(19) United States
(12) Patent Application Publication
(10) Pub. No.: US 2016/0131956 A1
(43) Pub. Date: May 12, 2016

(54) FLUORESCENT PARTICLES FOR ELECTROPHORETIC DISPLAYS

(71) Applicant: EMPIRE TECHNOLOGY DEVELOPMENT LLC, Wilmington, DE (US)

(72) Inventor: Josef Peter KLEIN, Vashon, WA (US)

(21) Appl. No.: 14/901,403

(22) PCT Filed: Jun. 26, 2013
(86) PCT No.: PCT/US2013/047885

§ 371 Date: Dec. 28, 2015

(51) Int. Cl. G02F 1/167; C09K 11/06; G02B 1/04

(52) U.S. Cl. CPC G02F 1/167; G02B 1/04; C09K 11/06; G02F 2001/1678; C09K 2211/1029; C09K 2211/1007

(57) ABSTRACT

Electrophoretic displays with an electrophoretic medium having charged fluorescent microparticles are disclosed. The microparticles are charged linking molecules polymerized with fluorophores of various emissive wavelengths so that microparticles that emit a variety of colors may be produced. Methods for producing the microparticles and using the microparticles in an electrophoretic display are also disclosed. Such microparticles may be provided separately, or kits may be provided for producing the microparticles.

### BACKGROUND

Electrophoretic displays, such as those that may be used in e-reader devices or other display applications, are displays based on an electrophoresis phenomenon influencing charged color particles suspended in a dielectric solvent. The color particles may be of a size of about 1-2 microns in diameter, carrying a charge, and are able to migrate within the dielectric solvent under the influence of externally applied charges from adjacent electrode plates or conducting films. The color particles may provide at least one visible color in the display.

Electrophoretic displays have an electrophoretic fluid having at least one type of charged color particle dispersed in the dielectric solvent. The electrophoretic fluid may be pigmented with a color that is in contrast to the color particles, for example, white particles in a colorless or clear dielectric solvent. Upon application of a charge to the electrode plates, the color particles may be influenced to migrate towards or away from the electrode plates, by attraction to a plate of opposite charge, or repulsion from a plate of similar charge. In this manner, the color showing at one surface may be either the color of the solvent if the particles are attracted away from that surface, or may be the color provided by the particles if the particles are attracted to that surface. Reversal of plate polarity may then cause the particles to migrate back to the opposite plate, thereby reversing the color.

Alternatively, an electrophoretic fluid may have two types of color particles of contrasting colors (for example, white and black) and carrying opposite charges, dispersed in a clear solvent. Upon application of a voltage difference between two electrode plates, the two types of color particles may move to opposite ends (top or bottom) in a display cell. Thus, one or the other of the colors provided by the two types of color particles would be visible at the viewing side of the display cell.

The color-providing particles may be ionic or ionizable microparticles composed of white, black or otherwise colored molecules encapsulated by a polymer. The color-providing particles may be formed from a non-covalent bonding of a polymer matrix to the encapsulated colored molecules. The non-covalent bonding may be broken down by radiant energy, resulting in a loss of color over time and rendering the electrophoretic display no longer functioning as designed. In addition, molecules that have color because of dyes may not be exceptionally bright as these molecules simply reflect ambient light.

For electrophoretic displays, there remains a need for charged color-providing particles which have improved color-fastness and photostability, and which are able to provide brighter colors for displays.

### SUMMARY

Micro- and nano-particle based approaches to electrophoretic displays employing fluorescent molecules that are covalently linked to the polymeric particle matrix can provide improved color-fastness and photostability. As the fluorescent molecules can emit light, they may also provide brighter colors for the displays.

In an embodiment, an electrophoretic display includes at least one first electrode layer and an electrophoretic medium disposed adjacent to the at least one first electrode layer. The electrophoretic medium includes at least one electrically charged particle disposed in a fluid and capable of moving through the fluid upon application of an electrical field to the fluid. The at least one charged particle includes a polymer having at least one fluorophore and at least one charged molecule.

In an embodiment, an electrophoretic medium includes at least one electrically charged particle disposed in a transparent fluid and capable of moving through the transparent fluid upon application of an electrical field to the transparent fluid. The at least one charged particle includes a polymer having at least one fluorophore and at least one charged molecule.

In an embodiment, a charged fluorescent particle includes a polymer having at least one fluorophore and at least one charged molecule.

In an embodiment, a method for producing charged fluorescent particles includes polymerizing fluorophore monomer units with charged monomer units to form the charged fluorescent particles.

In an embodiment, a kit for producing charged fluorescent particles includes fluorophores, and charged molecules configured to polymerize with the fluorophores to form charged fluorescent particles.

In an embodiment, a method of using an electrophoretic display is disclosed. The method includes providing an electrophoretic display to emit colored electromagnetic radiation from a surface of the display. The display includes at least one first electrode layer and an array of microcapsules disposed adjacent to the at least one first electrode layer with a first side of the microcapsules adjacent to the first electrode layer and a second side of the microcapsules away from the first electrode layer. Each microcapsule includes an electrophoretic medium of at least one electrically charged particle disposed in a transparent fluid and capable of moving through the transparent fluid upon application of an electrical field to the transparent fluid, wherein the at least one charged particle includes a polymer having at least one fluorophore and at least one charged molecule. The method also includes selectively applying an electric charge to the first electrode layer adjacent to selected microcapsules in the array to cause the at least one charged particle in the selected microcapsules to move away from the electrode layer to the second side of the selected microcapsules, and irradiating the display with electromagnetic radiation capable of fluorescing the at least one charged particle to emit a colored electromagnetic radiation from the second side of the selected microcapsules.

### BRIEF DESCRIPTION OF THE FIGURES

FIGS. 1A-1C are representative configurations of an electrophoretic display according to an embodiment.

FIGS. 2A and 2B depict representative polymerization reactions for producing charged fluorescent particles according to embodiments.

FIG. 3 depicts a representative reaction for functionalizing fluorescent dyes for polymerization according to an embodiment.

FIG. 4 depicts fluorescent dyes that may be used for fluorescent particles according to embodiments.

FIG. 5 depicts a charged molecule that may be used for fluorescent particles according to embodiments.

FIG. 6 depicts functionalized fluorescent dyes that may be used for fluorescent particles according to embodiments.

FIG. 7 depicts molecular radicals of fluorescent particle components according to embodiments.

### DETAILED DESCRIPTION

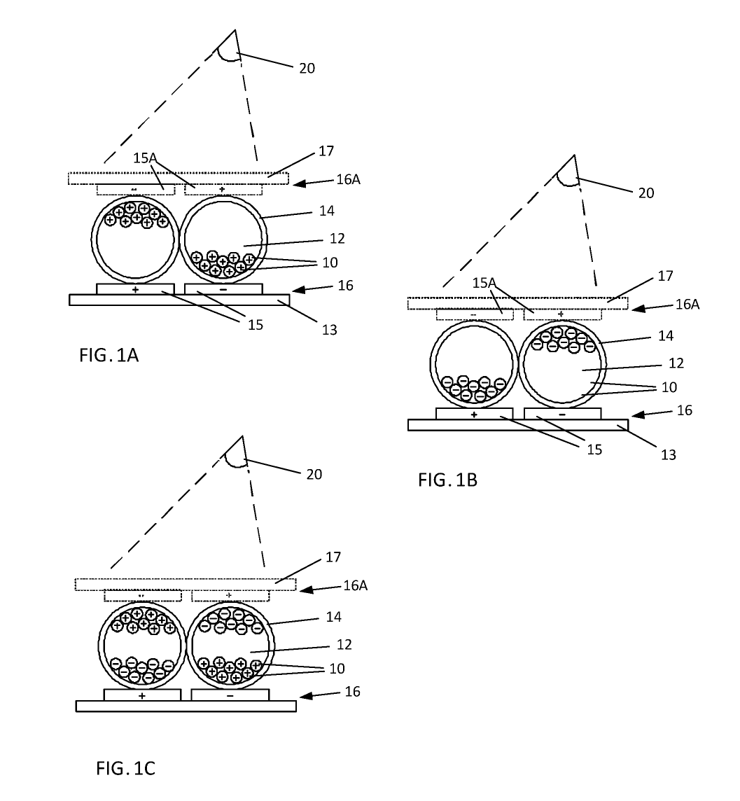

Charged polymeric fluorescent particles may be used to provide visible colors in both flexible and non-flexible display technologies, and provide improved hue, brightness, and color intensity as compared to non-fluorescent pigments and dyes. In addition, fluorescent dyes covalently bound to a polymer may provide improved color-fastness and photostability as compared to non-polymer bound pigments and dyes. Non-fluorescent pigments can simply reflect light at a particular wavelength or wavelengths, while fluorescent polymer particles may emit light at a particular wavelength or wavelengths, thereby providing brighter colors for displays such as electrophoretic displays. Electrophoretic displays incorporating such charged particles, for example as illustrated in FIGS. 1A-1C, may be used in a variety of devices, such as cellular telephones, e-book readers, tablet computers, portable computers, smart cards, signs, watches, or shelf labels, to name a few examples.

Charged fluorescent particles, such as those that may be used in electrophoretic displays, may include polymers having at least one fluorophore and at least one charged molecule. Fluorophore monomer units and charged monomer units may be configured and polymerized so that the resulting charged fluorescent polymer forms particles 10, as depicted in FIGS. 1A-1C. The particles 10 may be nanoparticles, microparticles, nanospheres, or microspheres, may have a size from about 1 nanometer to about 10 micrometers, and will, for simplification, be generally referred to as microparticles herein. A fluorescent molecule, or fluorophore, may be any molecular moiety which emits a visible color upon excitation with radiation of an appropriate wavelength.

At least one charged microparticle 10 may be encapsulated along with a suspension fluid 12 within at least one microcapsule 14. Alternatively, a plurality of the microparticles 10 may be present in each microcapsule 14. The suspension fluid 12 may be a dielectric solvent having a density that allows the microparticles to be suspended in the solvent, for movement within the solvent when an electric charge is applied to attract or repel the microparticles. In an embodiment, the density of the solvent may be approximately the same as the density of the microparticles 10. To allow for high particle mobility, the solvent or solvent mixture in the suspension fluid 12 in which the fluorescent particles are dispersed may have a low viscosity and a dielectric constant of about 2 to about 50. For example, the fluid may have a kinematic viscosity of about 0.2 centistokes to about 50 centistokes. Specific examples of kinematic viscosity include about 0.2, about 0.4, about 0.6, about 0.8, about 1, about 2, about 4 about 6, about 8, about 10, about 15, about 20, about 25, about 30, about 35, about 40, about 45, about 50, and any values or ranges between an of the listed values. In addition, the dielectric constant may be about 2 to about 50, about 2 to about 25, about 2 to about 20, or about 2 to about 15. Specific examples of dielectric constants include about 2, about 5, about 10, about 15, about 20, about 25, about 30, about 35, about 40, about 45, about 50, and ranges between any two of these values.

The solvent, or two or more solvents for the suspension fluid 12 may be selected such that the fluorescent microparticles are insoluble in the solvent, the long term chemical and structural stability of the fluorescent microparticles are maintained, and the solvent counteracts fluorescent quenching of the fluorescent microparticles. The solvent or solvents of suspension fluid 12 may be linear or branched hydrocarbon oil, halogenated hydrocarbon oil, silicone oil, water, decane epoxide, dodecane epoxide, cyclohexyl vinyl ether, naphthalene, tetrafluorodibromoethylene, tetrachloroethylene, trifluorochloroethylene, 1,2,4-trichlorobenzene, carbon tetrachloride, decane, dodecane, tetradecane, xylene, toluene, hexane, cyclohexane, benzene, an aliphatic hydrocarbon, naphtha, octamethyl cyclosiloxane, cyclic siloxanes, poly(methyl phenyl siloxane), hexamethyldisiloxane, polydimethylsiloxane, poly(chlorotrifluoroethylene) polymer, or combinations of any two or more of these.

Some additional examples of suitable dielectric solvents may include hydrocarbons such as isopar, decahydronaphthalene (DECALIN), 5-ethylidene-2-norbornene, fatty oils, paraffin oil; silicon fluids; aromatic hydrocarbons such as phenylxylylethane, dodecylbenzene and alkylnaphthalene; halogenated solvents such as perfluorodecalin, perfluorotoluene, perfluoroxylene, dichlorobenzotrifluoride, 3,4,5-trichlorobenzotrifluoride, chloropentafluoro-benzene, dichlorononane, pentachlorobenzene; and perfluorinated solvents such as FC-43, FC-70 and FC-5060 from 3M Company, St. Paul Minn., low molecular weight halogen containing polymers such as poly(perfluoropropylene oxide) from TCI America, Portland, Oreg., poly(chlorotrifluoro-ethylene) such as Halocarbon Oils from Halocarbon Product Corp., River Edge, N.J., perfluoropolyalkylether such as Galden from Ausimont or Krytox Oils and Greases K-Fluid Series from DuPont, Del., polydimethylsiloxane based silicone oil from Dow-Corning (DC-200). The solvent or solvent mixture may be visibly transparent, and, in addition, the solvent may be visibly colorless, or, alternatively, may be colored by a dye or pigment.

The microcapsules 14 may be formed of polymers and may be visually transparent for viewing of the contents therein. Additional types of micro-container units, or display cells, may be used in place of microcapsules 14. Micro-container units, or display cells, may include any type of separation units which may be individually filled with a display fluid. Some additional examples of such micro-container units may include, but are not limited to, micro-cups, micro-channels, other partition-typed display cells and equivalents thereof.

In an embodiment, the microcapsules 14 may be disposed adjacent to at least a first electrode layer 16 configured for applying a positive or negative charge adjacent to a side of the microcapsules. The first electrode layer 16 may be a conducting film, and may be flexible to allow for flexible displays. The first electrode layer 16 may have a base substrate 13 supporting individual electrodes 15 corresponding to each microcapsule 14

With a configuration as shown in FIG. 1A, wherein the polymer microparticles 10 have a positive charge, an application of a positive charge to the first electrode layer 16 adjacent to a microcapsule 14 may repel the microparticles away from the electrode, while an application of a negative charge to the first electrode layer adjacent to a microcapsule may attract the microparticles to the electrode. In this manner, if the suspension fluid 12 is of a first color, and the charged microparticles 10 are of a second color, the side of the microcapsules 14 (upper side in FIG. 1A) disposed away from the first electrode layer 16 will appear to a viewer 20 to have the color of the suspension fluid (right-side microcapsule in FIG. 1A) when the microparticles are attracted to the first electrode layer. On the other hand, the upper side of the microcapsules 14 will visually appear to have the color of the microparticles 10 (left-side microcapsule in FIG. 1A) when the microparticles are repelled away from first the electrode layer 16.

With a configuration as shown in FIG. 1B, wherein the polymer microparticles 10 have a negative charge, an application of a positive charge to the first electrode layer 16 adjacent to a microcapsule 14 may attract the microparticles to the electrode, while an application of a negative charge to the first electrode layer adjacent to a microcapsule may repel the microparticles away from the electrode.

In an alternative embodiment, instead of just one electrode layer 16, the display may also have a second electrode layer 16A (shown in dotted lines in FIGS. 1A-1C) of appropriate conducting material, and spaced apart from, and opposite to the first electrode layer 16. At least one face 17 may be formed as a transparent conducting material which may also act as a substrate material for the individual electrodes 15A which may be disposed on an inner surface of the second electrode layer 16A towards the first electrode layer 16. The microcapsules 14 may be sandwiched between the first electrode layer 16 and the second electrode layer 16A. Some examples of transparent conducting materials may include, but are not limited to, indium tin oxide (ITO) on polyester, aluminum zinc oxide (AZO), fluorine tin oxide (FTO), poly(3,4-ethylenedioxythiophene) (PEDOT), PEDOT with poly(styrene sulfonate) (PSS), poly(4,4-dioctylcyclopentadithiophene), and carbon nanotubes. A voltage difference may be imposed across the microcapsules 14 wherein one electrode layer may apply a charge which is opposite to the charge of the other electrode layer. In this manner, one side of the arrangement may attract the microparticles 10 while the other side repels the microparticles 10 to better facilitate movement of the microparticles through the suspension fluid 12.

The colors produced at the surface of face 17 of such electrophoretic displays may be promoted and/or enhanced by direct sunlight, other external lighting sources, or back-lighting.

As an alternative, as depicted in FIG. 1C, the visible color in microcapsules 14 may be produced by providing two sets of oppositely charged microparticles 10 in each microcapsule 14, wherein each set of microparticles 10 fluoresces a different color. For example, the positively charged particles may fluoresce red and the negatively charged particles may fluoresce yellow (or any other color combinations). Application of electric fields as shown, would attract the red-fluorescing (positive) particles to the negatively charged electrodes and the yellow fluorescing (negative) particles to the positively charged electrodes, and in the depiction of FIG. 1B, the upper surface in the left microcapsule would appear red, and the upper surface in the right microcapsule would appear yellow.

An electrophoretic display may be assembled as follows. A substrate having thin film transistor (TFT) elements may be coated with a photoresist layer by coating a resist material on the TFT glass substrate. Grooves arranged in an intended partition pattern may be formed in the photoresist layer by photolithography. The grooves may be supplied with a two-part curable silicone resin and the resin may be cured. Thereafter, the resulting photoresist layer may be exfoliated and removed from the substrate, whereby partitions formed of the silicone resin extending upward from the substrate may be formed. In an embodiment, an electrophoretic dispersion may be filled directly into the corresponding spaces defined by the partitions (cell spaces) using an ink-jet device, or as discussed above, microcapsules may be filled with the microparticles dispersion and the microcapsules may be introduced onto the substrate layer. A glass substrate with an ITO layer on an entire surface thereof may be placed over the cell spaces, and the periphery portion of the paired substrates may be sealed with an epoxy resin to produce an electrophoretic display device. The terminal section of the resulting electrophoretic display device may be coupled with a power source through lines to activate the device.

The microparticles 10 that are used in electrophoretic displays may be chosen, or configured, based on the desired colors required for the display. While black and white colors would be used, for example, in e-book readers which display a replica of a white page with black type, alternative particles that fluoresce additional individual colors may also be used. To provide color combinations, the microcapsules 14 of an array of microcapsules may individually be filled with microparticles that fluoresce different colors in a repeating pattern so that by activating selected ones of the microcapsules, individual colors, and color combinations may be achieved. Two common models for obtaining various colors and color combinations include the RYB or red-yellow-blue model which uses the named set of subtractive primary colors, or the RGB or red-green-blue model which uses the named set of additive primary colors.

As an example, in an RYB system, individual microcapsules may be provided containing the individual microparticles that fluoresce red, yellow, or blue, and the microcapsules may be arranged in a repeating array of the three colors. When a red-color is desired to be displayed, a negative charge may be selectively applied to the microcapsules containing the microparticles that fluoresce red, or alternatively, for yellow, a negative charge may be selectively applied to the microcapsules that fluoresce yellow. To produce orange, however, a negative charge may be selectively applied to the microcapsules containing red-fluorescing particles and to the microcapsules containing yellow fluorescing particles, so that the red fluorescence and yellow fluorescence combine to produce an orange color. This could be applied to any combination of microcapsules to produce a variety of colors.

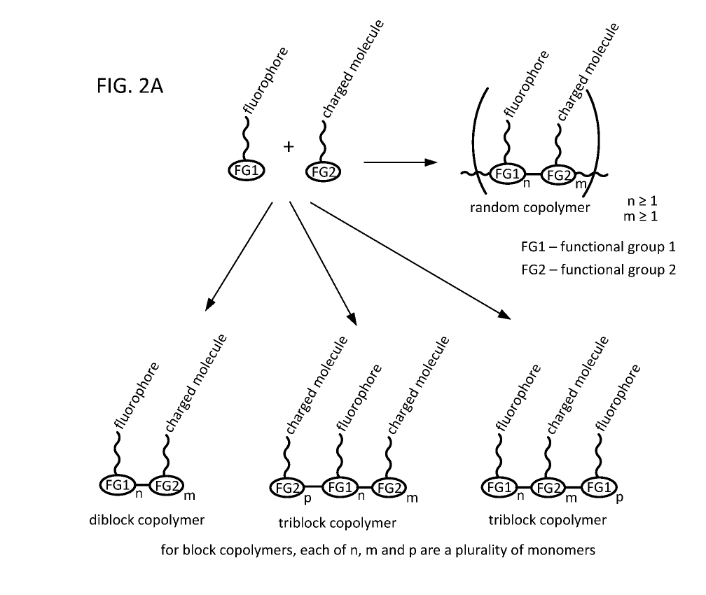

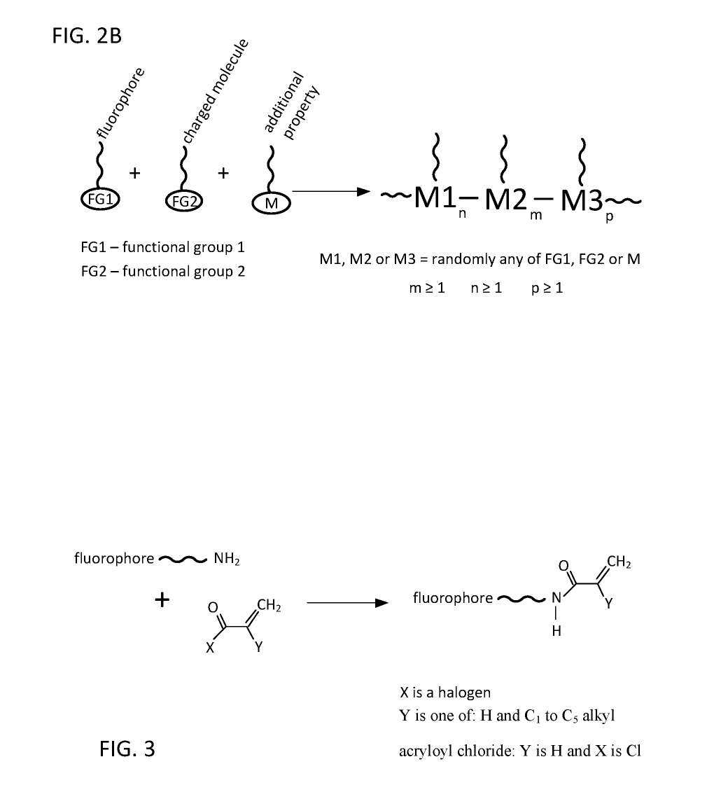

As mentioned above, each microparticle 10 may be a charged particle including a polymer having at least one fluorophore and at least one charged molecule. In an embodiment, the charged particles may be a polymer having at least one fluorophore and at least one charged molecule. As represented in FIG. 2A and discussed further below, the polymerization may be configured so that the fluorophores and the charged molecules may be randomly interspersed with one another in the polymer to form a random polymer, or the polymer may be a block copolymer of the fluorophores and the charged molecules.

In an embodiment, the charged particles may be copolymers of charged linking molecules and fluorophores wherein the fluorophores are derived from fluorophore monomer units comprising at least one polymerizable functional group, and the charged molecules are derived from charged monomer units comprising at least one polymerizable functional group. The fluorophore monomer units and the charged monomer units may be configured, or selected, such that the polymerizable functional groups of the fluorophore monomer units and of the charged monomer units are configured to polymerize with the polymerizable functional group of others of the fluorophore monomer units and charged monomer units.

The polymerizable functional group may be a vinyl group (CH₂═CH—), or a 1-ethylene substituted functional group (CH₂═CY—X—), wherein Y is at least one of: H and substituted or non-substituted alkyl, and X is at least one of: a substituted or non-substituted alkylene group, a substituted or non-substituted arylene group, a substituted or non-substituted aralkyl group, an S group, a CO group, a COO group, a COO—R group and a CON—R group wherein R represents a substituted or non-substituted alkylene group, a substituted or non-substituted aralkylene group, or a substituted or non-substituted arylene group. In embodiments, the 1-ethylene substituted functional groups include, but are not limited to, acrylo, methacrylo, acrylamido, methacrylamido, diallylamino, allyl ether, vinyl ether, alpha-alkenyl, maleimido, styrenyl, and alpha-alkyl styrenyl groups.

Some fluorescent dyes that do not have a polymerizable functional group as provided above, may be modified to include such a group. In an embodiment, fluorescent dyes that are carboxylic-reactive, or have a free amino group, may be modified, for example, by treatment with a halogenated acryloyl, or methacryloyl compound, such as acryloyl chloride, in the presence of a non-nucleophilic base, such as diisopropylethyl amine, to attach the acrylic functional group to the dye. This reaction is represented in FIG. 3.

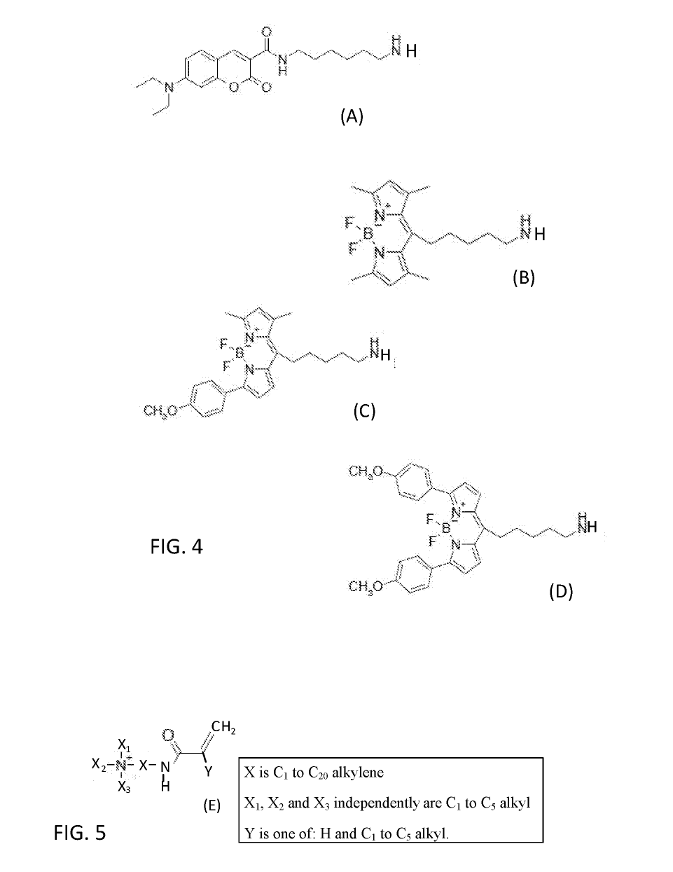

Some examples of fluorescent dyes that may be modified to include the acrylic functional group include the CHROMIS fluorescent dyes (Cambridge Research Biochemicals, Billingham, UK) listed in Table 1, and structurally represented in FIG. 4 with letter designations corresponding to TABLE 1.

TABLE 1

| | Excitation | Emission | Emission |
|---|---|---|---|
| Fluorescent Dye | (nm) | (nm) | Color |
| (A) CHROMIS 425 N amine | 425 | 476 | blue |
| (B) CHROMIS 500 L5H N amine | 496 | 506 | green |
| (C) CHROMIS 530 L5H N amine | 529 | 561 | yellow |
| (D) CHROMIS 570 L5H N amine | 573 | 612 | red |

Additional examples of dyes (including excitation wavelength, emission wavelength and color) that may be used include dansyl ethylenediamine (excitation 410 nm, emission 512 nm, green), dansyl cadaverine (excitation 333 nm, emission 518 nm, green), Lissamine Rhodamine B ethylenediamine (excitation 561 nm, emission 581 nm, red), tetramethylrhodamine-5-carboxamide cadaverine (5-TAMRA cadaverine, excitation 545 nm, emission 576 nm, orange), tetramethylrhodamine-6-carboxamide cadaverine (6-TAMRA cadaverine, excitation 545 nm, emission 577 nm, orange), sulforhodamine 101 cadaverine (Texas red cadaverine, excitation 595 nm, emission 615 nm, red), BODIPY FL ethylenediamine (excitation 503 nm, emission 510 nm, green), and BODIPY TR cadaverine (excitation 588 nm, emission 616 nm, red).

The charged monomer units that are polymerized with the fluorophore monomer units may include anions to provide negatively charged particles, or cations to provide positively charged particles, and any of the above-listed functional groups. In an embodiment for positively charged particles, the charged monomers may include quaternary ammonium cations, quaternary phosphonium cations, quaternary arsonium cations, quaternary stibonium cations, ternary sulfonium cations, or any combination thereof. As an example, the charged monomer units may be cationic acrylamides (E) in FIG. 5.

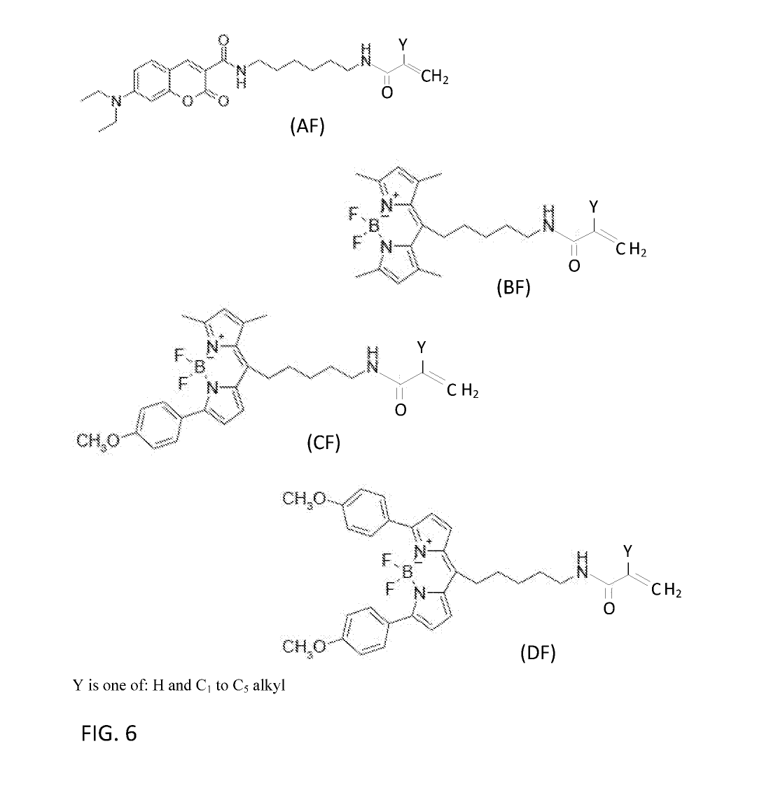

Charged monomer units and fluorophore monomer units having appropriate functional groups as set forth above, may be polymerized by free-radical polymerization methods. In an embodiment, the charged monomer units and the fluorophore monomer units may be functionalized with an acrylamide or alkyl-acrylamide functional group. Representative functionalized structures of the above Chromis dyes (A, B, C, D), functionalized in a manner as set forth above, are shown in FIG. 6, correspondingly as AF, BF, CF and DF. In an embodiment, the polymer may be a copolymer of at least one molecular species of the fluorophore and at least one molecular species of the charged molecule.

To produce a random polymer or copolymer of charged monomer units and fluorophore monomer units, for example, a copolymer as represented in FIG. 2A, both the charged monomer units and fluorophore monomer units may be introduced into a reaction vessel, and the reaction conditions may be adjusted to initiate and carry out polymerization. Under such a reaction scenario, either a monomer unit or a fluorophore unit may randomly attach to any other monomer unit or fluorophore unit to produce polymer chains, so that the resulting polymers may have random arrangements of fluorophores and charged molecules. If additional monomers are desired to be included in the polymer as in FIG. 2B, the additional monomers may be included in the reaction vessel to randomly attach to the other monomer units to produce polymers having random arrangements of fluorophores, charged molecules, and additional monomers that may provide additional desired properties to the polymer as discussed below.

The radical polymerization may be a living radical polymerization such as atom transfer radical polymerization (ATRP), reverse addition—fragmentation transfer (RAFT) polymerization, or nitroxide mediated stable free radical polymerization (SFRP).

Alternatively, the radical polymerization may be emulsion polymerization such as mini-emulsion or micro-emulsion polymerization. As represented in FIG. 2B, emulsion polymerization methods used in the synthesis of polyacrylamide particles may employ various reagents for optimization of particle properties including particle size. These reagents may include additional monomer components (M) such as acrylamide, methacrylamide, N-alkylacrylamides, N,N-dialkylacrylamides, N-alkylmethacrylamides, N,N-dialkylmethacrylamides, acrylic acid, methacrylic acid, alkyl acrylates, alkyl methacrylates, acrylonitrile and styrene, crosslinking reagents such as N,N′-alkylenebis(acrylamide)s, ionic surfactants such as sodium alkyl sulfates and dialkyl sodium succinates, non-ionic surfactants such as polyoxyethylene alkyl ethers, free radical initiators such as ultraviolet light, persulfate salts, hydrogen peroxide, organic peroxides and azo compounds including azobisisobutyronitrile (AIBN), and free radical stabilizers such as N,N,N′,N′-tetramethylethylenediamine (TMEDA).

Depending on the fluorophore monomer units, the charged monomer units and the functional groups attached thereto, a general representation of a random polymer or copolymer produced under such conditions may be represented by the structure (S1)

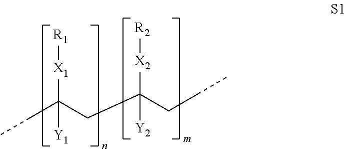

wherein n≧1 and m≧1, R₁ is the fluorophore, R₂ is the charged molecule, Y₁ is at least one of: H and substituted or non-substituted alkyl, Y₂ is at least one of: H and substituted or non-substituted alkyl, and X₁ and X₂ are at least one of: a covalent bond, a substituted or non-substituted alkylene group, a substituted or non-substituted arylene group, a substituted or non-substituted aralkyl group, an S group, a CO group, a COO group, a COO—R group and a CON—R group, wherein R represents a substituted or non-substituted alkylene group, a substituted or non-substituted aralkylene group, or a substituted or non-substituted arylene group.

In an embodiment wherein the fluorophores are modified to include the acrylamide or alkyl-acrylamide functional group as described above, and the charged monomer units are acrylamides or alkyl-acrylamides of the above-listed cations, a general representation of a polymer produced under such conditions may be represented by the structure (S2)

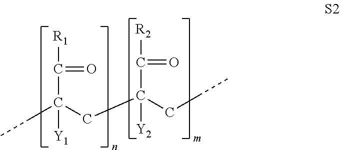

wherein n≧1 and m≧1, Y₁ is at least one of: H and substituted or non-substituted alkyl, Y₂ is at least one of: H and substituted or non-substituted alkyl, R₁ is derived from a fluorophore having at least one free aminyl group and is covalently bonded to a C═O group via a nitrogen of at least one aminyl group, and R₂ is a cation derived from the group consisting of quaternary ammonium, quaternary phosphonium, quaternary arsonium, quaternary stibonium, and ternary sulfonium cations, and is covalently bonded to the C═O group via at least one aminyl nitrogen.

In an additional embodiment the polymer as represented by S2 may be further modified to include at least one additional monomer unit (M) configured to provide additional properties to the polymer (cross-linkability, size, shape, hydrophilicity, hydrophobicity, stability, optical, electronic, etc). A general representation of such a random polymer produced under such conditions may be represented by the structure (S3)

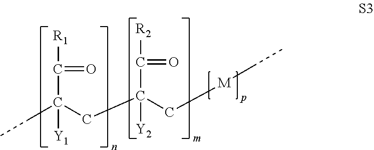

wherein n, m and p are individually ≧1. In addition, Y₁, Y₂, are individually at least one of: H and substituted or non-substituted alkyl. The monomer units containing either R₁ or R₂, and the at least one M monomer units are randomly interspersed among one another within the polymer. R₁ is derived from a fluorophore having at least one free aminyl group and is covalently bonded to a C═O group via a nitrogen of at least one aminyl group. R₂ is a cation derived from the group consisting of quaternary ammonium, quaternary phosphonium, quaternary arsonium, quaternary stibonium, and ternary sulfonium cations, and is covalently bonded to the C═O group via at least one aminyl nitrogen. M may a monomer having one or more of: acrylamide, methacrylamide, N-alkylacrylamides, N,N-dialkylacrylamides, N-alkylmethacrylamides, N,N-dialkylmethacrylamides, acrylic acid, methacrylic acid, alkyl acrylates, alkyl methacrylates, acrylonitrile and styrene, crosslinking reagents such as N,N′-alkylenebis(acrylamide)s, ionic surfactants such as sodium alkyl sulfates and dialkyl sodium succinates, non-ionic surfactants such as polyoxyethylene alkyl ethers, free radical initiators such as ultraviolet light, persulfate salts, hydrogen peroxide, organic peroxides and azo compounds including azobisisobutyronitrile (AIBN), and free radical stabilizers such as N,N,N′,N′-tetramethylethylenediamine (TMEDA).

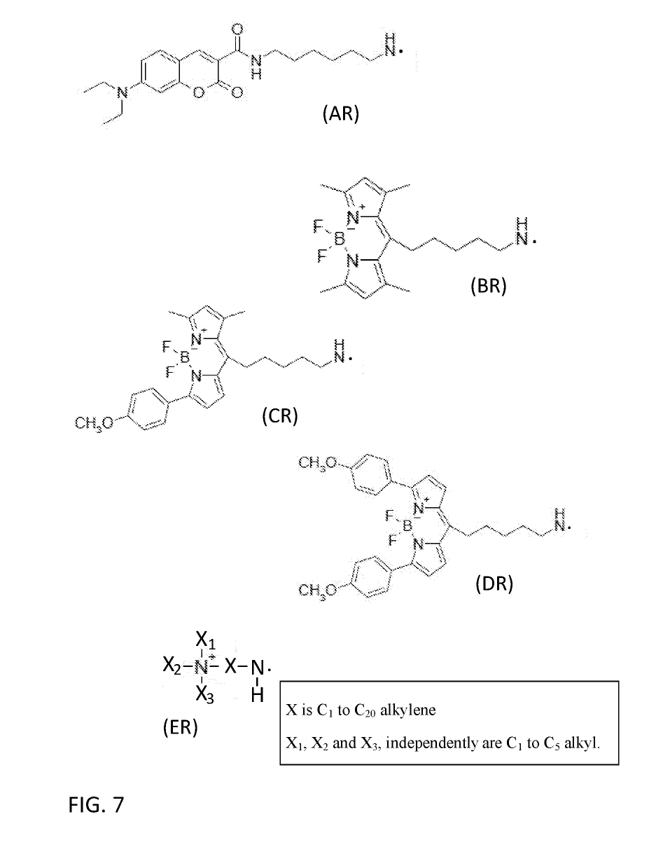

As examples, and with reference to FIG. 7, in an embodiment for charged particles that emit blue-colored electromagnetic radiation, in the structure (S2) above, R₁ may represent the fluorophore radical (AR) from the Chromis 425 N amine dye. In an embodiment for charged particles that emit green-colored electromagnetic radiation, R₁ may represent the fluorophore radical (BR) from the Chromis 500 L5H N amine dye. In an embodiment for charged particles that emit yellow-colored electromagnetic radiation, R₁ may represent the fluorophore radical (CR) from the Chromis 530 L5H N amine dye. In an embodiment for charged particles that emit red-colored electromagnetic radiation, R₁ may represent the fluorophore radical (DR) from the Chromis 570 L5H N amine dye.

For any of the charged fluorescent particles represented by the structure (S2), R₂ may represent the charged molecule radical (ER) shown in FIG. 7.

In addition to random copolymers as discussed above, the charged fluorescent particles may also be formed as block copolymers as represented in FIG. 2A. To produce a block copolymer of charged molecules and fluorophores, in a first polymerization step, only charged monomer units or fluorophore monomer units may be introduced into a reaction vessel, and the reaction conditions may be adjusted to initiate and carry out a first polymerization. In this first step, a polymer chain, or block of only charged monomer units or fluorophore monomer units will be produced. In a second reaction step, the resultant blocks of the first reaction step may be introduced into a reaction vessel with only the other of the charged monomer units or fluorophore monomer units to then add to the chains with the other monomer units, and attach a block of the other monomer units to the original block of units and produce a diblock copolymer. Additional blocks may then be added in a similar manner by placing the diblock copolymers back into a reaction vessel with the original monomer units to thereby add a third block of monomer units and produce a triblock copolymer. The triblock copolymer may be represented by either: fluorophores-charged molecules-fluorophores; or charged molecules-fluorophores-charged molecules. This process may be repeated as desired to form alternating blocks of the polymer constituents.

Charged fluorescent particles, such as, for example, any of the embodiments as discussed above, may be produced and marketed in a final polymeric form. Alternatively, the components for producing the particles could be sold in kit form to allow an end user to produce the particles on site, for example, and possibly on an ‘as-needed’ basis. Such a kit may be for producing microparticle that emit only one color, and may include the fluorophores that emit the color, as well as the charged linker molecules for being polymerized with the fluorophores to form the charged fluorescent particles. Alternatively, such a kit may be for producing a first batch of microparticles that emit one color as well as a second batch of microparticles that emit another color, or any combination of batches of microparticles that emit particular colors.

Such a kit, for example, may include fluorophores with a polymerizable functional group and charged linking molecules with a polymerizable functional group, wherein the polymerizable functional groups of the fluorophores and of the charged molecules are configured to polymerize with the polymerizable functional group of others of the fluorophores and charged molecules The fluorophores, charged linking molecules and polymerizable functional groups may be any of the components as previously discussed.

For particles that emit blue color, the kit may include functionalized fluorophores (AF) of FIG. 6 and charged molecules (E) of FIG. 5.

For particles that emit green color, the kit may include functionalized fluorophores (BF) of FIG. 6 and charged molecules (E) of FIG. 5.

For particles that emit yellow color, the kit may include functionalized fluorophores (CF) of FIG. 6 and charged molecules (E) of FIG. 5.

For particles that emit red color, the kit may include functionalized fluorophores (DF) of FIG. 6 and charged molecules (E) of FIG. 5.

A kit may include any combination of, or all of the components for producing any combination of, or all of the red-colored microparticles, the blue-colored microparticles, or the yellow-colored microparticles. In an additional embodiment, a kit may also be configured as a kit for producing an electrophoretic medium and may include a suitable solvent in addition to components for the microparticles. The solvent may be a single-component solvent or solvent mixture selected from the solvent list as previously provided. In a further embodiment, a kit may also be configured as a kit for producing microcapsules filled with an electrophoretic medium. Such a kit may include components for producing the microparticles, a suitable solvent, and also microcapsules or micro-container units for being filled with the electrophoretic medium. The microcapsules and micro-container units may be selected from the examples as previously provided. In another embodiment, a kit may also be configured as a kit for producing an electrophoretic display. As such, the kit may include components for producing the microparticles, a suitable solvent, micro-container units, and electrode layers. The electrode layers plates may be selected from the examples as previously provided.

### EXAMPLES

### Example 1

### Production of Fluorescent Charged Microparticles for Emitting Red-Colored Light

Fluorescent charged microparticles that emit red-colored light are produced by functionalizing the Chromis 570 L5H N amine dye (D) in FIG. 4. The Chromis dye (D) is treated with acryloyl chloride as shown in FIG. 3, in the presence of a non-nucleophilic base. To a mixture of Chromis 570 L5H N (1 equivalent), triethylamine (1.2 equivalents) and dichloromethane (5 mL per equivalent of fluorophore), cooled in an ice bath, is added slowly a solution of acryloyl chloride (1.05 equivalents) in dichloromethane (1 ml per equivalent of acryloyl chloride). After being stirred for about 2 hours, the mixture is concentrated under vacuum and the residue is treated with water and extracted with dichloromethane. The extract is dried over magnesium sulfate and concentrated under reduced pressure to yield the functionalized dye (DF). The resultant functionalized dye (DF) in FIG. 6 is then co-polymerized with (3-acrylamidopropyl)trimethylammonium chloride ((E) of FIG. 5 having X₁, X₂ and X₃═CH₃, X═C₃H₆, Y═H, and an associated chloride ion) and an alkyl acrylamide by employing micro-emulsion polymerization conditions. A solution of N-isopropylacrylamide (1.41 g), N,N′-methylenebis(acrylamide) (16 mg), functionalized dye (DF) (40 mg), (3-acrylamidopropyl)trimethylammonium chloride (40 mg) and sodium dodecylsulfate (25 mg) is mixed with deionized water (100 mL). The mixture is heated at 70° C. and purged of oxygen by bubbling with nitrogen gas for 30 minutes. A solution of ammonium persulfate (100 mg) in deionized and deoxygenated water is added to the mixture while stirring with a paddle stirrer (200 rpm). After stirring at 70° C. for about 1.5 hours, the suspension is cooled to ambient temperature and dialyzed against water for 4 days with water exchanged twice daily. The aqueous solution is lyophilized to yield red fluorescent cationic polymeric nanospheres. The resultant random polyacrylamide polymer of the fluorophores and the charged molecules is able to fluoresce red-colored light of 612 nm wavelength upon excitation with electromagnetic radiation of about 573 nm.

### Example 2

### A Kit for Producing Charged Fluorescent Microparticles

A kit will be configured for producing colors for an RGB output device. The kit will include components for producing each of: microparticles that emit red-colored light, microparticles that emit green-colored light, and microparticles that emit blue-colored light. The microparticles may be produced using the method of Example 1.

For the red-light emitting microparticles, the kit will include functionalized dyes (DF) as shown in FIG. 6. For the green-light emitting microparticles, the kit will include functionalized dyes (BF). For the blue-light emitting microparticles, the kit will include functionalized dyes (AF). The kit will also include sufficient 3-acrylamidopropyl)trimethyl-ammonium chloride as the charged molecules to polymerize with each of the three dye components.

### Example 3

### An Electrophoretic Medium

An electrophoretic medium for use in electrophoretic displays may include any of the fluorescent microparticles that may be produced, for example, from the kit of Example 2, and according to the procedure of Example 1. An electrophoretic medium having about 1 volume % to about 30 volume % charged particles for producing a red color in an electrophoretic display will be made by dispersing the red-fluorescing particles of Example 1 in a hydrocarbon oil. Similarly, for any additional color desired, an electrophoretic medium having about 1 volume % to about 30 volume % charged particles for producing the desired color may be made by dispersing the appropriate fluorescing particles in a hydrocarbon oil

### Example 4

### An Electrophoretic Display

Each individual electrophoretic medium of Example 3 will be encapsulated within individual urea/melamine/formaldehyde microcapsules of about 50 micrometer diameter. The microcapsules will be dispersed in a regular repeating pattern of colors, red-green-blue-red-green-blue, etc., on a conductive plates of indium tin oxide (ITO) on polyester, and the plate will be connected to electrical circuitry that allows external signals to manipulate the electric charge at different precise points on the plate corresponding to individual microcapsules.

### Example 5

### A Dual Layer Electrophoretic Display

Each individual electrophoretic medium of Example 3 will be encapsulated within individual urea/melamine/formaldehyde microcapsules of about 50 micrometer diameter. The microcapsules will be dispersed in a regular repeating pattern of colors, red-green-blue-red-green-blue, etc., between two parallel conductive plates of indium tin oxide (ITO) on polyester, spaced about 50 micrometers apart, and the plates will be connected to electrical circuitry that allows external signals to manipulate the electric charge at different precise points on the plates corresponding to individual microcapsules.

### Example 6

### Method of Using an Electrophoretic Display

An electrophoretic display as produced in Example 5 having red, green and blue fluorescing microcapsules is provided as a color display in a cell-phone with the second electrode plate on top for viewing. An additional illuminating plate will be provided over the second electrode plate to expose the microcapsules to fluorescent light of a wavelength of at least about 400 nm to about 600 nm.

Since the microparticles are negatively charged, to activate the microcapsules a positive charge will be applied to the second plate adjacent the desired microcapsules to be activated, while a negative charge will be applied to the first plate. The microparticles in the activated microcapsules will then move towards the second plate to visibly fluoresce color at the second plate for viewing. To remove the colors from viewing, the charges will be reversed at the plates to withdraw the microparticles away from the second plate. As an example: to produce red in a portion of the display, individual microspheres containing red-fluorescing microparticles will be activated; to change the viewable color from red to green in that portion of the display, the red-fluorescing microspheres will be de-activated and the individual microspheres containing green-fluorescing microparticles will be activated; and to subsequently produce yellow in that same portion of the display, the microspheres containing the red-fluorescing microparticles will again be activated so that both red and green colors will be fluoresced to produce yellow.

This disclosure is not limited to the particular systems, devices and methods described, as these may vary. The terminology used in the description is for the purpose of describing the particular versions or embodiments only, and is not intended to limit the scope.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, components, compositions or biological systems, which can, of course, vary. It is also to be understood that the terminology used herein is for the purpose of describing particular embodiments only, and is not intended to be limiting.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” or “comprises” or “comprise” means “including, but not limited to.”

While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. An electrophoretic display comprising:
at least one first electrode layer configured to selectively apply an electric field; and
an electrophoretic medium disposed adjacent to the at least one first electrode layer, wherein the electrophoretic medium comprises:
a fluid having a first color; and
at least one electrically charged particle disposed in the fluid, wherein the at least one electrically charged particle is configured to move in the fluid when the electrical field is applied, wherein the at least one charged particle comprises:
a polymer having at least one fluorophore; and
at least one charged molecule configured to emit a second color different from the first color of the fluid.

2. The electrophoretic display of claim 1, wherein the electrophoretic medium is disposed in at least one microcapsule.

3.-6. (canceled)

7. The electrophoretic display of claim 1, wherein the fluid comprises at least one of: linear or branched hydrocarbon oil, halogenated hydrocarbon oil, silicone oil, water, decane epoxide, dodecane epoxide, cyclohexyl vinyl ether, naphthalene, tetrafluorodibromoethylene, tetrachloroethylene, trifluorochloroethylene, 1,2,4-trichlorobenzene, carbon tetrachloride, decane, dodecane, tetradecane, xylene, toluene, hexane, cyclohexane, benzene, an aliphatic hydrocarbon, naphtha, octamethyl cyclosiloxane, cyclic siloxanes, poly(methyl phenyl siloxane), hexamethyldisiloxane, polydimethylsiloxane, and poly(chlorotrifluoroethylene) polymer.

8. The electrophoretic display of claim 1, further comprising:
a first substrate with a first surface, wherein the at least one first electrode layer is disposed on the first surface;
a second substrate with a second surface, wherein the second substrate is spaced apart from and opposite to the first substrate to define a chamber between the first substrate and the second substrate;
a second electrode layer disposed on the second surface of the second substrate such that the second electrode layer faces the first electrode layer; and
a plurality of microcapsules located in the chamber between the first electrode layer and the second electrode layer, wherein the plurality of microcapsules contain the electrophoretic medium therein.

9.-12. (canceled)

13. The electrophoretic display of claim 1, wherein:
the at least one fluorophore is derived from fluorophore monomer units comprising at least one polymerizable functional group;
the at least one charged molecule is derived from charged monomer units comprising at least one polymerizable functional group; and
the polymerizable functional groups of the fluorophore monomer units and the charged monomer units are configured to polymerize with the polymerizable functional group of others of the fluorophore monomer units and the charged monomer units.

14. The electrophoretic display of claim 13, wherein the polymerizable functional groups comprise 1-ethylene substituted functional groups comprising functional groups represented by the chemical structure: CH₂═CY—X—, wherein Y is at least one of: H and substituted or non-substituted alkyl, and X is at least one of: a substituted or non-substituted alkylene group, a substituted or non-substituted arylene group, a substituted or non-substituted aralkyl group, an S group, a CO group, a COO group, a COO—R group and a CON—R group, wherein R represents a substituted or non-substituted alkylene group, a substituted or non-substituted aralkylene group, or a substituted or non-substituted arylene group.

15.-18. (canceled)

19. The electrophoretic display of claim 1, wherein the polymer has a random repeating structure of formula 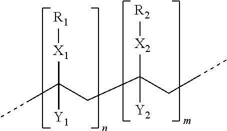
wherein:
n≧1 and m≧1;
R₁ is the fluorophore;
R₂ is the charged molecule;
Y₁ is at least one of: H and substituted or non-substituted alkyl;
Y₂ is at least one of: H and substituted or non-substituted alkyl; and
X₁ and X₂ are at least one of: a covalent bond, a substituted or non-substituted alkylene group, a substituted or non-substituted arylene group, a substituted or non-substituted aralkyl group, an S group, a CO group, a COO group, a COO—R group and a CON—R group, wherein R represents a substituted or non-substituted alkylene group, a substituted or non-substituted aralkylene group, or a substituted or non-substituted arylene group.

20. (canceled)

21. The electrophoretic display of claim 1, wherein the polymer has a random structure of at least three monomer units M₁, M₂, and M₃, wherein M₁ comprises the fluorophore, M₂ comprises the charged molecule, and M₃ comprises at least one additional monomer unit configured for providing at least one additional property to the polymer, and the at least one additional property is selected from the group consisting of size, shape, cross-linkability, hydrophilicity, hydrophobicity, stability, optical, electronic and combinations thereof.

22. The electrophoretic display of claim 21, wherein:
M₁ has the formula 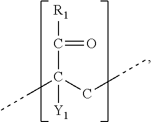
M₂ has the formula 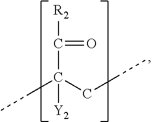
wherein:
Y₁ is at least one of: H and substituted or non-substituted alkyl;
Y₂ is at least one of: H and substituted or non-substituted alkyl;
R₁ is derived from a fluorophore having at least one free aminyl group and is covalently bonded to a C═O group via a nitrogen of the at least one aminyl group; and
R₂ is a cation derived from the group consisting of quaternary ammonium, quaternary phosphonium, quaternary arsoniutn, quaternary stibonium, and ternary sulfonium cations, and is covalently bonded to a C═O group via at least one aminyl nitrogen; and
M₃ is a monomer comprising a constituent selected from the group consisting of acrylamide, methacrylamide, N-alkylacrylamides, N,N-di alkylacrylamides, N-alkylmethacrylamides, N,N-dialkylmethacrylamides, acrylic acid, methacrylic acid, alkyl acrylates, alkyl methacrylates, acrylonitrile, styrene, N,N′-alkylenebis(acrylamide)s, sodium alkyl sulfates, dialkyl sodium succinates, polyoxyethylene alkyl ethers, persulfate salts, hydrogen peroxide, organic peroxides, azo compounds, azobisisobutyronitrile (AIBN), N,N,N′,N′-tetramethylethylenediamine (TMEDA), and combinations thereof.

23. The electrophoretic display of claim 22, wherein R₁ is 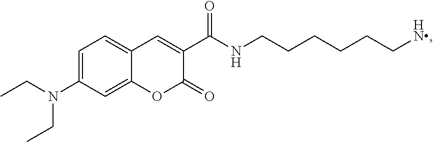
and the particle is configured to emit blue-colored electromagnetic radiation upon excitation with electromagnetic radiation of about 425 nm.

24. The electrophoretic display of claim 22, wherein R₁ is 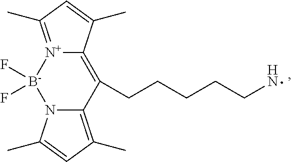
and the particle is configured to emit green-colored electromagnetic radiation upon excitation with electromagnetic radiation of about 496 nm.

25. The electrophoretic display of claim 22, wherein R₁ is 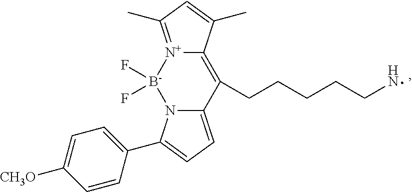
and the particle is configured to emit yellow-colored electromagnetic radiation upon excitation with electromagnetic radiation of about 529 nm.

26. The electrophoretic display of claim 22, wherein R₁ is 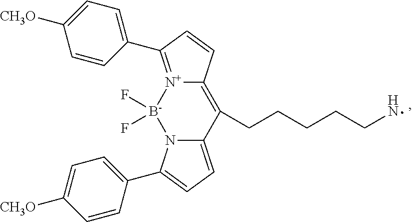
and the particle is configured to emit red-colored electromagnetic radiation upon excitation with electromagnetic radiation of about 573 nm.

27. The electrophoretic display of claim 22, wherein R₂ is 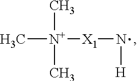
and X₁ is C₁ to C₂₀ alkylene.

28. An electrophoretic medium comprising at least one electrically charged particle disposed in a fluid and configured to move in the fluid when an electrical field is applied to the fluid, wherein the at least one charged particle comprises a polymer having at least one fluorophore and at least one charged molecule.

29.-32. (canceled)

33. The electrophoretic medium of claim 28, wherein the fluid comprises at least one of: linear or branched hydrocarbon oil, halogenated hydrocarbon oil, silicone oil, water, decane epoxide, dodecane epoxide, cyclohexyl vinyl ether, naphthalene, tetrafluorodibromoethylene, tetrachloroethylene, trifluorochloroethylene, 1,2,4-trichlorobenzene, carbon tetrachloride, decane, dodecane, tetradecane, xylene, toluene, hexane, cyclohexane, benzene, an aliphatic hydrocarbon, naphtha, octamethyl cyclosiloxane, cyclic siloxanes, poly(methyl phenyl siloxane), hexamethyldisiloxane, polydimethylsiloxane, and poly(chlorotrifluoroethylene) polymer.

34. The electrophoretic medium of claim 28, wherein:
the at least one fluorophore is derived from fluorophore monomer units comprising at least one polymerizable functional group;
the at least one charged molecule is derived from charged monomer units comprising at least one polymerizable functional group; and
the polymerizable functional groups of the fluorophore monomer units and the charged monomer units are configured to polymerize with the polymerizable functional group of others of the fluorophore monomer units and the charged monomer units.

35-39. (canceled)

40. The electrophoretic medium of claim 28, wherein the polymer has a random repeating structure of formula 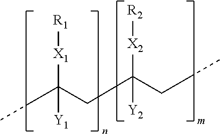
wherein:
n≧1 and m≧1;
R₁ is the fluorophore;
R₂ is the charged molecule;
Y₁ is at least one of: H and substituted or non-substituted alkyl;
Y₂ is at least one of: H and substituted or non-substituted alkyl; and
X₁ and X₂ are at least one of: a covalent bond, a substituted or non-substituted alkylene group, a substituted or non-substituted arylene group, a substituted or non-substituted aralkyl group, an S group, a CO group, a COO group, a COO—R group and a CON—R group, wherein R represents a substituted or non-substituted alkylene group, a substituted or non-substituted aralkylene group, or a substituted or non-substituted arylene group.

41. (canceled)

42. The electrophoretic medium of claim 40, wherein R₂ is 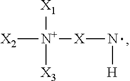
and X is C₁ to C₂₀ alkylene, and X₁, X₂ and X₃ are C₁ to C₅ alkyl.

43. The electrophoretic medium of claim 40, wherein R₁ is 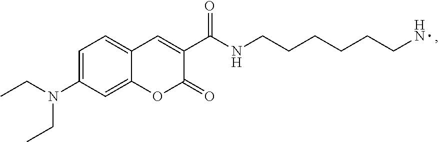
and the particle is configured to emit blue-colored electromagnetic radiation upon excitation with electromagnetic radiation of about 425 nm.

44. The electrophoretic medium of claim 40, wherein R₁ is 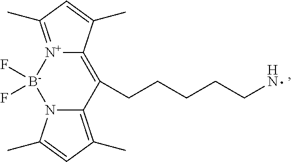
and the particle is configured to emit green-colored electromagnetic radiation upon excitation with electromagnetic radiation of about 496 nm.

45. The electrophoretic medium of claim 40, wherein R₁ is 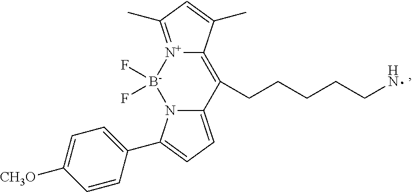
and the particle is configured to emit yellow-colored electromagnetic radiation upon excitation with electromagnetic radiation of about 529 nm.

46. The electrophoretic medium of claim 40, wherein R₁ is 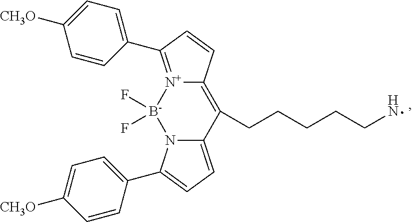
and the particle is configured to emit red-colored electromagnetic radiation upon excitation with electromagnetic radiation of about 573 nm.

47.-48. (canceled)

49. A charged fluorescent particle comprising a polymer having covalently bonded thereto at least one fluorophore and at least one charged molecule.

50.-58. (canceled)

59. The charged fluorescent particle of claim 49, wherein the polymer has a random repeating structure of formula 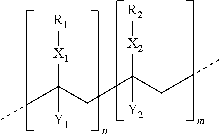
wherein:
n≧1 and m≧1;
R₁ is the fluorophore;
R₂ is the charged molecule;
Y₁ is at least one of: H and substituted or non-substituted alkyl;
Y₂ is at least one of: H and substituted or non-substituted alkyl; and
X₁ and X₂ are at least one of: a covalent bond, a substituted or non-substituted alkylene group, a substituted or non-substituted arylene group, a substituted or non-substituted aralkyl group, an S group, a CO group, a COO group, a COO—R group and a CON—R group, wherein R represents a substituted or non-substituted alkylene group, a substituted or non-substituted aralkylene group, or a substituted or non-substituted arylene group.

60. The charged fluorescent particle of claim 49, wherein the polymer has a random repeating structure of formula 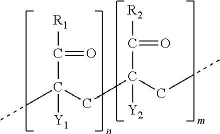
wherein:
n≧1 and m≧1;
Y₁ is at least one of: H and substituted or non-substituted alkyl;
Y₂ is at least one of: H and substituted or non-substituted alkyl;
R₁ is derived from a fluorophore having at least one free aminyl group and is covalently bonded to a C═O group via a nitrogen of the at least one aminyl group; and
R₂ is a cation derived from the group consisting of quaternary ammonium, quaternary phosphonium, quaternary arsonium, quaternary stibonium, and ternary sulfonium cations, and is covalently bonded to a C═O group via at least one aminyl nitrogen.

61. The charged fluorescent particle of claim 60, wherein R₁ is derived from a fluorophore selected from the group consisting of CHROMIS 425 N amine, CHROMIS 500 L5H N amine, CHROMIS 530 L5H N amine, CHROMIS 570 L5H N amine, dansyl ethylenediamine, dansyl cadaverine, Lissamine Rhodamine B ethylenediamine, tetramethylrhodamine-5-carboxamide cadaverine, tetramethyl rhodamine-6-carboxamide cadaverine, sulforhodamine 101 cadaverine, BODIPY FL ethylenediamine, and BODIPY TR cadaverine.

62.-70. (canceled)

71. The charged fluorescent particle of claim 49, wherein the polymer has a random structure of at least three monomer units M₁, M₂, and M₃, wherein M₁ comprises the fluorophore, M₂ comprises the charged molecule, and M₃ comprises at least one additional monomer unit configured for providing at least one additional property to the polymer, and the at least one additional property is selected from the group consisting of size, shape, cross-linkability, hydrophilicity, hydrophobicity, stability, optical, electronic, and combinations thereof.

72. The charged fluorescent particle of claim 71, wherein:
M₁ has the formula 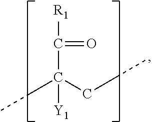
M₂ has the formula 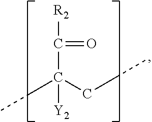
wherein:
Y₁ is at least one of: H and substituted or non-substituted alkyl;
Y₂ is at least one of: H and substituted or non-substituted alkyl;
R₁ is derived from a fluorophore having at least one free aminyl group and is covalently bonded to a C═O group via a nitrogen of the at least one aminyl group; and
R₂ is a cation derived from the group consisting of quaternary ammonium, quaternary phosphonium, quaternary arsonium, quaternary stibonium, and ternary sulfonium cations, and is covalently bonded to a C═O group via at least one aminyl nitrogen; and
M₃ is a monomer comprising a constituent selected from the group consisting of acrylamide, methacrylamide, N-alkylacrylamides, N,N-di alkylacrylamides, N-alkylmethacrylamides, N,N-dialkylmethacrylamides, acrylic acid, methacrylic acid, alkyl acrylates, alkyl methacrylates, acrylonitrile, styrene, N,N′-alkylenebis(acrylamide)s, sodium alkyl sulfates, dialkyl sodium succinates, polyoxyethylene alkyl ethers, persulfate salts, hydrogen peroxide, organic peroxides, azo compounds, azobisisobutyronitrile (AIBN), N,N,N′,N′-tetramethylethylenediamine (TMEDA), and combinations thereof.

73.-116. (canceled)

117. A charged fluorescent particle comprising a polymer having at least one fluorophore and at least one charged molecule, wherein the polymer has a random repeating structure of formula 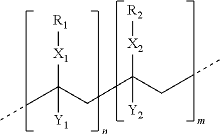
wherein:
n≧1 and m≧1;
R₁ is the fluorophore;
R₂ is the charged molecule;
Y₁ is at least one of: H and substituted or non-substituted alkyl;
Y₂ is at least one of: H and substituted or non-substituted alkyl; and
X₁ and X₂ are at least one of: a covalent bond, a substituted or non-substituted alkylene group, a substituted or non-substituted arylene group, a substituted or non-substituted aralkyl group, an S group, a CO group, a COO group, a COO—R group and a CON—R group, wherein R represents a substituted or non-substituted alkylene group, a substituted or non-substituted aralkylene group, or a substituted or non-substituted arylene group.
